(19) United States
(12) Patent Application Publication
(10) Pub. No.: US 2026/0111071 A1
(43) Pub. Date: Apr. 23, 2026

(54) POWER SAVING FOR DISPLAY PANELS

(71) Applicant: QUALCOMM Incorporated, San Diego, CA (US)

(72) Inventors: Venkata Ajay SARRAJU, Hyderabad (IN); Rajasekhar Reddy BOMMU, Hyderabad (IN); Sri Krishna Chaitanya MADIREDDY, Hyderabad (IN)

(21) Appl. No.: 18/920,801

(22) Filed: Oct. 18, 2024

(51) Int. Cl. G06F 1/3234; G06F 3/147

(52) U.S. Cl. CPC G06F 1/3265; G06F 3/147

(57) ABSTRACT

This disclosure provides systems, devices, apparatus, and methods, including computer programs encoded on storage media, for saving power at display panels. A processor may obtain, from an operating system framework, an indication of a set of static content regions of a display. The processor may map the set of static content regions to a set of segments of the display based on the obtained indication of the set of static content regions of the display. The processor may assign an attribute to at least a subset of the mapped set of segments of the display based on a static content setting. The processor may output, to a driver of the display, an indication of the assigned attribute for at least the subset of the set of segments of the display.

### TECHNICAL FIELD

The present disclosure relates generally to processing systems, and more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address power loss to portions of display panels that do not update meaningful content. There is a need for improved power optimization techniques for display panels.

### BRIEF SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor may be configured to obtain, from an operating system framework, an indication of a set of static content regions of a display. The processor may be configured to map the set of static content regions to a set of segments of the display based on the obtained indication of the set of static content regions of the display. The processor may be configured to assign an attribute to at least a subset of the mapped set of segments of the display based on a static content setting. The processor may be configured to output, to a driver of the display, an indication of the assigned attribute for at least the subset of the set of segments of the display.

In some aspects, the techniques described herein relate to a method of display processing, including: obtaining, from an operating system framework, an indication of a set of static content regions of a display; mapping the set of static content regions to a set of segments of the display based on the obtained indication of the set of static content regions of the display; assigning an attribute to at least a subset of the mapped set of segments of the display based on a static content setting; and outputting, to a driver of the display, an indication of the assigned attribute for at least the subset of the set of segments of the display.

In some aspects, the techniques described herein relate to a method, where the set of segments includes segments of a set of light emitting diode (LED) panels.

In some aspects, the techniques described herein relate to a method, where the set of segments includes segments of a set of light emitting diode (LED) panels, where mapping the set of static content regions to the set of segments of the display includes: obtaining, from the driver of the display, a map that correlates sets of pixel coordinates to each segment of the set of segments of the set of LED panels; and mapping the set of static content regions to the set of segments of the display based on the obtained map that correlates the sets of pixel coordinates to each segment of the set of segments of the set of LED panels.

In some aspects, the techniques described herein relate to a method, where the attribute includes at least one of: a brightness setting, where the brightness setting is less than a default brightness setting of the display; a frame rate setting, where the frame rate setting is less than a default frame rate setting of the display; a backlight power off setting; or a power off setting.

In some aspects, the techniques described herein relate to a method, where obtaining, from the operating system framework, the indication of the set of static content regions of the display includes: obtaining, from the operating system framework, an indication of a set of dirty content regions of the display; and determining the set of static content regions of the display based on the obtained indication of the set of dirty content regions of the display.

In some aspects, the techniques described herein relate to a method, further including: mapping the set of dirty content regions of the display to a second set of segments of the display; and refraining from outputting, to the driver of the display, the indication of the assigned attribute for the second set of segments based on the mapped second set of segments of the display.

In some aspects, the techniques described herein relate to a method, further including: obtaining, from a user interface, an indication to automatically adjust the attribute for at least a portion of the set of segments of the display, where refraining from outputting, to the driver of the display, the indication of the assigned attribute for the second set of segments based on the mapped second set of segments includes: refraining from outputting, to the driver of the display, the indication of the assigned attribute for the second set of segments in response to the indication to automatically adjust the attribute for at least the portion of the set of segments of the display.

In some aspects, the techniques described herein relate to a method, further including: obtaining, from a user interface, an indication of a set of adjustable content regions of the display, where assigning the attribute to at least the subset of the mapped set of segments of the display based on the static content setting includes: assigning the attribute to at least the subset of the mapped set of segments of the display further based on the obtained indication of the set of adjustable content regions of the display.

In some aspects, the techniques described herein relate to a method, further including: obtaining, from the user interface, an indication to manually select the set of adjustable content regions of the display, where assigning the attribute to at least the subset of the mapped set of segments of the display further based on the obtained indication of the set of adjustable content regions of the display includes: assigning the attribute to at least the subset of the mapped set of segments of the display further based on the obtained indication of the set of adjustable content regions of the display in response to the indication to manually select the set of adjustable content regions of the display.

In some aspects, the techniques described herein relate to a method, further including: obtaining, from a user interface, an indication of the static content setting before assigning the attribute to at least the subset of the set of segments of the display based on the static content setting.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIGS. 4A-4B illustrate an example of a mobile device with a display having a dirty region and a static region, in accordance with one or more techniques of this disclosure.

FIGS. 5A-5D illustrate an example of a mobile device with a display having a plurality of segments and a plurality of dirty regions, in accordance with one or more techniques of this disclosure.

FIG. 6 is a call flow diagram illustrating example communications between a computer processing unit (CPU) and a device driver (DD), in accordance with one or more techniques of this disclosure.

FIG. 7 is another call flow diagram illustrating example communications between a CPU and a DD, in accordance with one or more techniques of this disclosure.

FIG. 8 is a call flow diagram illustrating example communications between a CPU and a user interface (UI), in accordance with one or more techniques of this disclosure.

FIG. 9 is another call flow diagram illustrating example communications between a CPU and a UI, in accordance with one or more techniques of this disclosure.

FIG. 10 is another call flow diagram illustrating example communications between a CPU and a UI, in accordance with one or more techniques of this disclosure.

FIG. 11 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented, or a method may be practiced, using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor, may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

In some examples, a processor (or display processor system) may obtain, from an operating system framework, an indication of a set of static content regions of a display. The operating system framework may include, for example, a build type of Android® or a version of iOS® for a mobile device. An indication of a static content region may be, for example, a set of pixel coordinates that identify borders or edges of the static content region or a dirty content region. A region that has static content may be an area of a display where the content in that area does not update for a threshold amount of time. Similarly, a region that has dirty content may be an area of a display where at least some content in that area updates at least once within a threshold amount of time. A static content region may also be referred to as a non-region of interest (non-ROI) region. The processor may map the set of static content regions to a set of segments of the display based on the obtained indication of the set of static content regions of the display. A segment of a display may be a contiguous area of the display, for example a defined area of a display panel, with an attribute (e.g., brightness setting, backlight setting, frame rate setting) that can be adjusted by a single command to a display driver controlling the display. The processor may assign an attribute to at least a subset of the mapped set of segments of the display based on a static content setting. The static content setting may be a setting that the processor may assign to a segment that is determined to be at least partially associated with (e.g., at least a portion of the segment contains static content), or wholly associated with (e.g., every displayed area of the segment contains static content), static content. In some aspects, the static content setting may be a default value saved as a setting of a mobile device. In some aspects, a user interface may be configured to receive an indication from a user of a user desire for the static content setting, for example whether to reduce the brightness of segments associated with static content, or to turn off the backlight of segments associated with static content. The processor may output, to a driver of the display, an indication of the assigned attribute for at least the subset of the set of segments of the display. The assigned attribute may include, for example, a brightness setting (e.g., lowering the brightness of a segment), a backlight power off setting (e.g., turning off the backlight in a segment), or a power off setting (e.g., turning off hardware of the segment). Assigning the attribute to the subset of the mapped set of segments of the display may reduce the power consumption of non-ROI areas of the display.

Aspects of the subject matter described in this disclosure can be implemented to realize one or more of the following potential advantages. In some examples, by strategically assigning low-power attributes to segments of a display, the described techniques can be used to decrease power consumption of a display of segments that do not have ROI areas. The feature may be software controlled, for example via a settings application on a mobile device. The feature may dynamically identify user regions to generate power savings that are easily observed. Any hindrance to the user experience may be overcome by turning off the feature in the settings application. The examples described herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

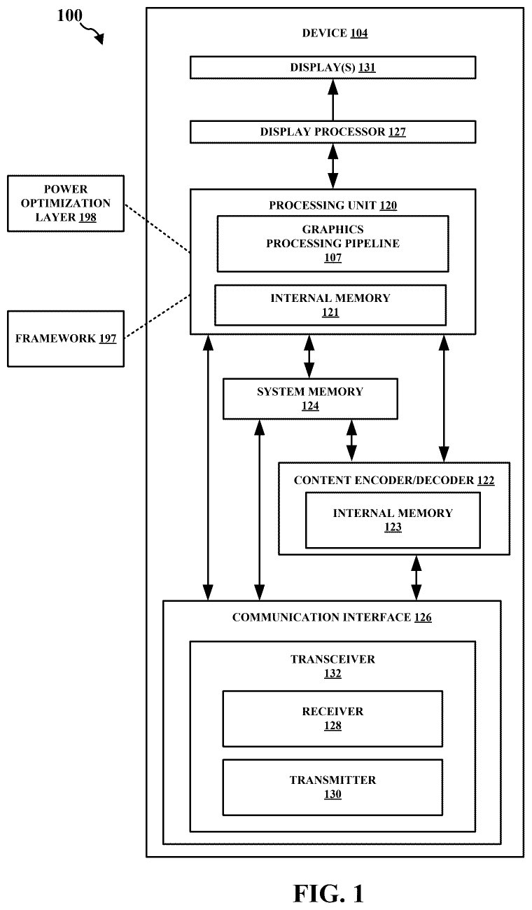

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display, and the second display may be a right-eye display. In some examples, the first display and the second display may receive different frames for presentment thereon. In other examples, the first and second display may receive the same frames for presentation thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content. The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104 or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, or similar, may be considered to be one or more processors. The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a power optimization layer 198 configured to obtain, from the framework 197, an indication of a set of static content regions of a display. The framework 197 may include an operating system (e.g., Linux®) that has user space libraries. The framework 197 may allow a system layer, for example a settings application on a mobile device, to obtain display information, such as the coordinates of a set of dirty regions and/or a set of static regions of a display. The framework 197 may include, for example, an API that responds to a query for display information from the power optimization layer 198. The power optimization layer 198 may be configured to map the set of static content regions to a set of segments of the display based on the obtained indication of the set of static content regions of the display. The power optimization layer 198 may be configured to assign an attribute to at least a subset of the mapped set of segments of the display based on a static content setting. The power optimization layer 198 may be configured to output, to a driver of the display, an indication of the assigned attribute for at least the subset of the set of segments of the display. Although the following description may be focused on display processing, the concepts described herein may be applicable to other similar processing techniques. A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

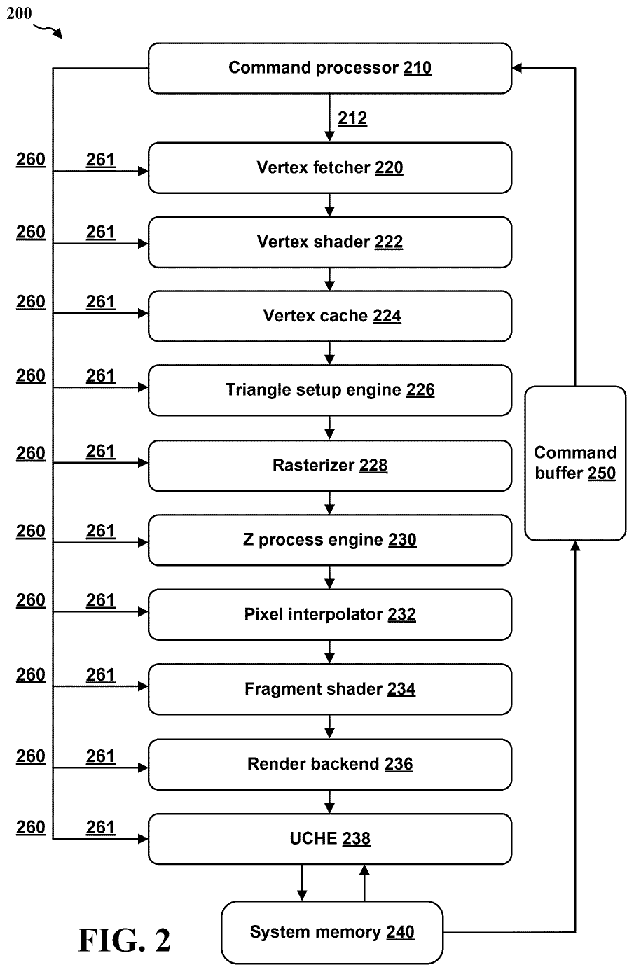

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example, and one or more GPUs may use any combination or order of processing units according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, which cover all of the draws in one surface. Further, GPUs can cycle through all of the draws in one bin and perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

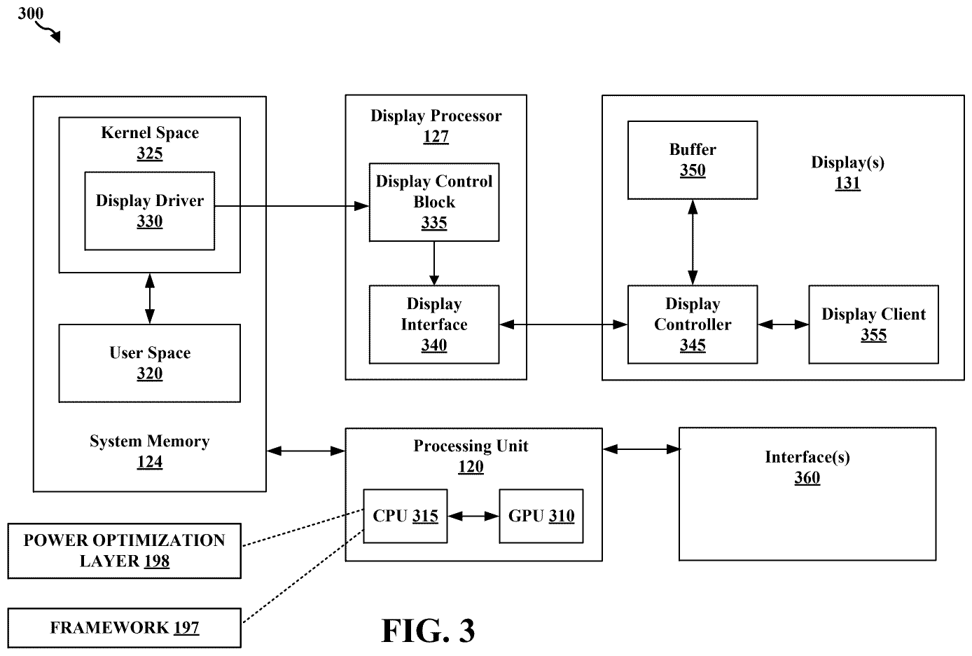

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

As shown, the CPU 315, when executing code from the system memory 124, may be configured to implement both the framework 197 and the power optimization layer 198. The CPU 315 may execute the framework 197 based on code in the kernel space 325 and may execute the power optimization layer 198 based on code in the user space 320. In other words, the power optimization layer 198 may operate in a higher layer than the framework 197. The power optimization layer 198 may use either the CPU 315 or the GPU 310 to determine the coordinates of the display segments and assign attributes to mapped segments based on the determined coordinates.

The processing unit 120 may communicate with a set of interfaces 360, for example a set of input user interfaces, a set of output user interfaces, and/or a set of communication interfaces, for example transceivers that transmit and/or receive data from other devices.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120. The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, which operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the display(s) 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be a set of layers, and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

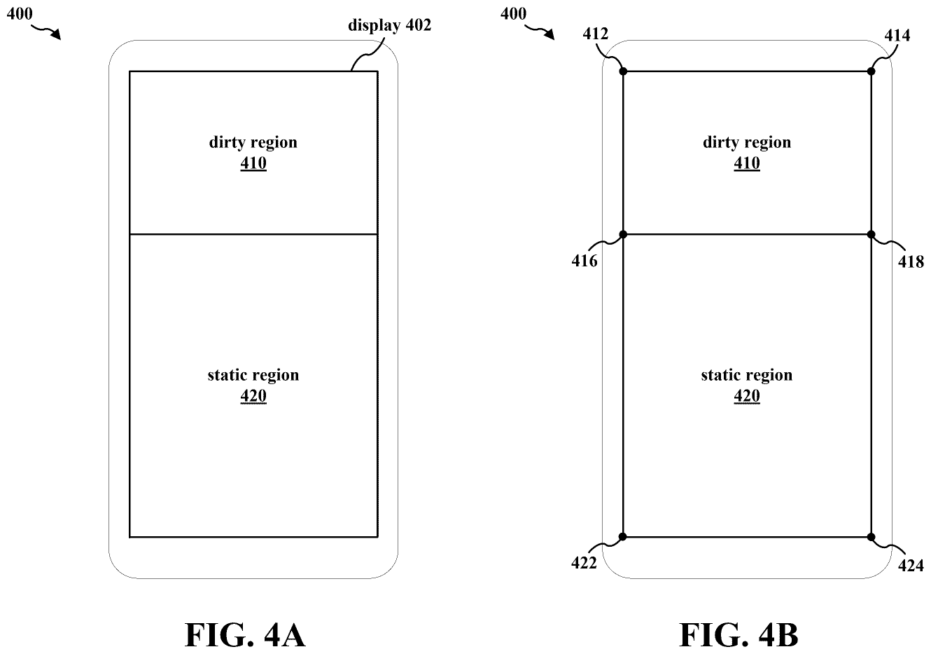

FIG. 4A illustrates an example of a mobile device 400 with a display 402. The display 402 may be a light emitting diode (LED) display, for example a display that includes a set of mini-LED panels. The display 402 may be a touch screen device that acts as a user interface (UI) that both accepts an input from a user and displays an output screen to the user. The mobile device 400 may be any computer system having a display, for example a smart phone that is configured to execute a plurality of applications having a video output, for example an application that streams video content to the display 402, or a gaming application that outputs a game screen to the display 402. A set of applications on the mobile device 400 may display visual content to the entirety of the display 402, however a user may focus on a portion of the display 402, for example a portion of the display 402 that includes video content or some other content that changes over time. In some aspects, the content on a portion of the display may be static—in other words, content on a portion of the display may not change over a threshold period of time (e.g., within 0.1 seconds, within 1 seconds, within 5 seconds). In some aspects, at least 50% of the screen may be static, for example when watching a video stream on the display 402 with metadata about the video on over 50% of the screen.

For example, the display 402 may have a dirty region 410 and a static region 420. The dirty region 410 may be a region of the display that updates over time. An operating system framework may be configured to identify a set of dirty regions and/or a set of static regions for the display 402. For example, an operating system framework, for example the framework 197 in FIG. 1, may analyze display information from a set of applications on the mobile device 400 to determine what portions of the display 402 are displaying information in a time period (e.g., within the next 0.1 seconds). The operating system framework may determine that the static region 420 does not update for a threshold period of time (e.g., so long as a video in the dirty region 410 plays and a user does not provide an input command to scroll the screen up or down).

FIG. 4B illustrates the mobile device 400 of FIG. 4A highlighting the coordinates 412, 414, 416, and 418 that define the dirty region 410, and the coordinates 416, 418, 422, and 424 that define the static region 420. The coordinates 412, 414, 416, 418, 422, and 424 may be referred to as pixel coordinates for a display following an (x, y) format. For example, the coordinate 412 may be the pixel coordinate (0,0), the coordinate 414 may be the pixel coordinate (50,0), the coordinate 416 may be the pixel coordinate (0, 30), the coordinate 418 may be the pixel coordinate (50, 30), the coordinate 422 may be the pixel coordinate (0, 100), and the coordinate 424 may be the pixel coordinate (50, 100).

A power optimization layer may be configured to query an operating system framework to determine the pixel coordinates of a set of dirty regions and/or a set of static regions. For example, the power optimization layer may output a command to an operating system framework to periodically transmit dirty region pixel coordinates for a period of time, or may periodically output (e.g., every 0.1 seconds) a command to an operating system framework to transmit dirty region pixel coordinates so long as a feature to adjust an attribute of the static content regions of the display is activated. In response to a request for coordinates, the operating system framework may output coordinates that define the dirty region 410, for example the coordinates 412, 414, 416, and 418. In response to a request for coordinates, the operating system framework may output coordinates that define the static region 420, for example the coordinates 416, 418, 422, and 424. In some aspects, a power optimization layer may determine a set of static region coordinates based on a set of dirty region coordinates that are received from the operating system framework. For example, a power optimization layer may determine a set of static region coordinates by subtracting coordinate-defined dirty region areas from the sum total of pixel coordinates of a display (e.g., the overall screen length and width coordinates). For example, if the display 402 has pixel coordinates from (0,0) to (50,100), and an operating system framework outputs an indication that the pixel coordinates (0,0), (50,0), (0, 30), and (50, 30) define the dirty region 410 of the display 402, then the power optimization layer may determine that the static region 420 of the display 402 is defined by the pixel coordinates (0, 31), (50, 31), (0, 100), and (50, 100). In other words, portions of a display may be defined as either dirty content regions or static content regions, and a power optimization layer may determine static content regions as any regions of a display that do not have any dirty content. In summary, the operating system framework may provide system coordinates of a set of dirty regions, or a set of static regions, to the power optimization layer.

In a specific example, the operating system framework may determine that a video is displaying within the dirty region 410 at 30 frames per second (fps). If the entire screen of the display 402 refreshes at a set refresh rate (e.g., 90 Hz, 144 Hz) and/or the entire screen of the display 402 has an activated display backlight at a default backlight setting (e.g., subject to surrounding light conditions), the display 402 may consume at least a threshold amount of power, even if the dirty region 410 covers less than 50% of the display 402. If the dirty region 410 displays a video stream that plays at a rate of 10-15 minutes, the power consumption of continuing to display the entire screen of the display 402 until the end of the video stream can be significant. The mobile device 400 may conserve power consumption by internally adjusting attributes for segments, or zones, of the display 402. While the mobile device 400 may individually adjust attributes for individual pixels, adjusting attributes for individual pixels is computationally expensive and may use complex commands. By adjusting attributes for entire segments at a device driver level (i.e., a hardware level), the mobile device 400 may perform simple commands to save power in entire segments of the display, which is computationally less expensive and uses less signaling.

As an example, the mobile device 400 may be configured to internally map the static region coordinates (e.g., the coordinates of the static region 420), to the dimming segments available in the display 402. A programmer may obtain such data from a manufacturer's data sheet. The mobile device 400 may control these dimming segments from the user space based on an interface provided by a display driver. When such a power-saving feature is enabled (e.g., via a simple mode setting by an end user), the power optimization layer may be configured to detect the dirty region 410 and turn on dimming for the entirety of the static region 420. If there is a new update on the display 402 for the static region 420, the power optimization layer may automatically detect this change in the boundary of the dirty region 410 and accordingly turn on the dimming zone that correlates with the new dirty region. A user may completely turn off this feature via a settings application of the mobile device 400.

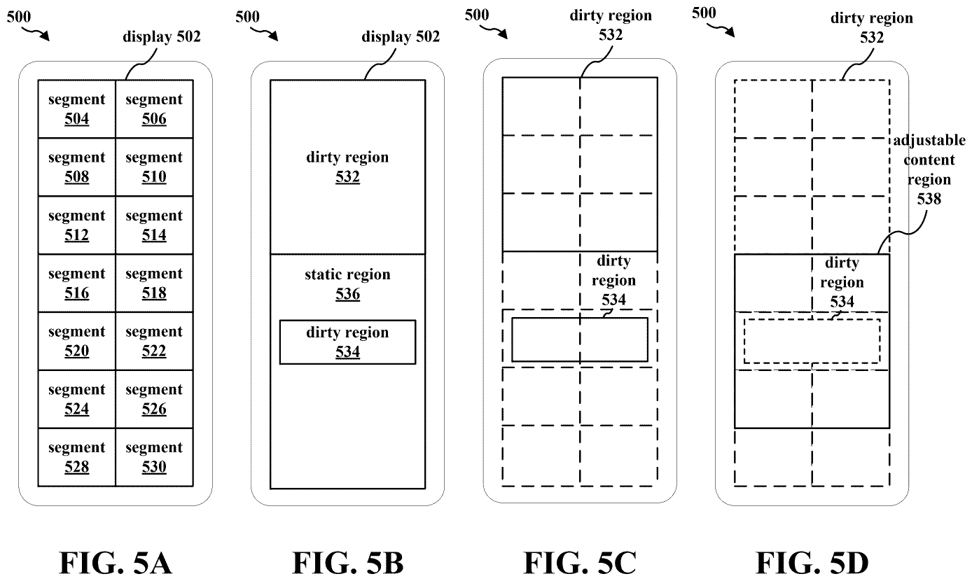

FIG. 5A illustrates an example of a mobile device 500 with a display 502, similar to the display 402 of FIG. 4A. The display 502 may be a set of LED panels, or mini-LED panels. The display 502 may have a set of segments, shown in FIG. 5A as segments 504, 506, 508, 510, 512, 514, 516, 518, 520, 522, 524, 526, 528, and 530, which may also be referred to as the set of segments of the display 502. Each of the set of segments of the display 502 may be hardware-specific groups of pixels that can be controlled as a group, for example via a command to a device driver. For example, a power optimization layer may transmit a command to a display driver (DD) to turn off (e.g., deactivate hardware, set the brightness level to 0) the segments 504, 506, 508, 510, 512, 514, 516, 518, 520, 522, 524, 526, 528, and 5. In another example, a power optimization layer may transmit a command to a DD to turn off the backlight to the segment 512. By changing attributes of the display 502 segment-by-segment at the hardware level via the DD of the display 502, instead of pixel-by-pixel at the software level, the mobile device 500 may conserve power resources.

The set of segments of the display 502 may be mapped to pixel coordinates of the display 502. In one aspect, the segment 504 may be defined by the pixel coordinates (0, 0), (25, 0), (0, 20), and (25, 20), and the segment 506 may be defined by the pixel coordinates (25, 0), (50, 0), (25, 20), and (50, 20). The mapping between the set of segments of the display 502 and the pixel coordinates of the display 502 may be correlated in a variety of ways. For example, a mapping between the pixel coordinates of the display 502 and the set of segments of the display 502 may be defined by a manufacturer's data sheet. In another example, a mapping between the pixel coordinates of the display 502 and the set of segments of the display 502 may be provided via a query to the DD of the display 502.

FIG. 5B illustrates an example of the mobile device 500 in FIG. 5A with a dirty region 532, a dirty region 534, and a static region 536. The operating system framework of the mobile device 500 may provide the pixel coordinates of the dirty region 532 and the dirty region 534, or the pixel coordinates of the static region 536, to the power optimization layer of the mobile device 500. As shown in FIG. 5C, the power optimization layer may learn that the segments 504, 506, 508, 510, 512, and 514 correlate with the dirty region 532, the segments 516, 518, 520, 522, 524, 526, 528, and 530 correlate with the static region 536, and the segments 520 and 522 correlate with both the dirty region 532 and the static region 536. In other words, the pixels of the dirty region 532 are within the pixel coordinates defined by the segments 504, 506, 508, 510, 512, and 514, the pixels of the static region 536 are within the pixel coordinates defined by the segments 516, 518, 520, 522, 524, 526, 528, and 530, and the pixels of the dirty region 532 are within the pixel coordinates defined by the segments 520 and 522.

The power optimization layer may be configured to associate a power saving attribute (e.g., reduce brightness level from a default level, set the brightness level to zero, turn off the segment, turn off a backlight, reduce a refresh rate) with any segment that is correlated with a static region, or may be configured to associate a power saving attribute to any segment that is correlated with a static region and is not correlated with a dirty region. In other words, in one aspect, the power optimization layer may turn off the backlight to the segments 516, 518, 524, 526, 528, and 530 to reduce power consumption at the mobile device 500 (i.e., segments correlated with a static region and not correlated with a dirty region), and in another aspect, the power optimization layer may turn off the backlight to the segments 516, 518, 520, 522, 524, 526, 528, and 530 to reduce power consumption at the mobile device 500 (i.e., any segments correlated with a static region).

In some aspects, one or more settings of the power optimization layer may be defined in a settings user interface of the mobile device 500. For example, a user may define the attribute to be associated with the subset of the segments of the display 502, such as a brightness setting (e.g., a brightness of 20% where the default brightness is 60%, or a brightness of 25% of the default brightness), a frame rate setting (e.g., in fps), whether to turn the backlight off, or whether to turn the segment off (or set the brightness to zero). In another example, a user may set the power optimization layer to automatically detect whether a segment is associated with a static region or is associated with a static region and is not associated with a dirty region and apply the attribute to the segment automatically. In another example, a user may set the power optimization layer to manually receive input from a user regarding whether to apply an attribute to a set of segments designated by the user. As shown in FIG. 5D, the user may indicate to the power optimization layer an adjustable content region 538, which may be a user-defined area (e.g., an area defined by a user's swipe across the display 502), which the power optimization layer may associated with a subset of the set of segments of the display 502. In other words, the adjustable content region may be defined by a user to indicate to the power optimization layer which segments of the display 502 may be adjusted, and which segments of the display 502 may not be adjusted, even if such segments include portions of a static region. The power optimization layer may then shut off that designated subset, if that subset is correlated with a static region, or is correlated with a static region and is not correlated with a dirty region. In another example, a user may set the power optimization layer to not associate an attribute with a segment in response to whether the segment is correlated with a dirty/static region. In other words, the user may turn off the power-saving feature.

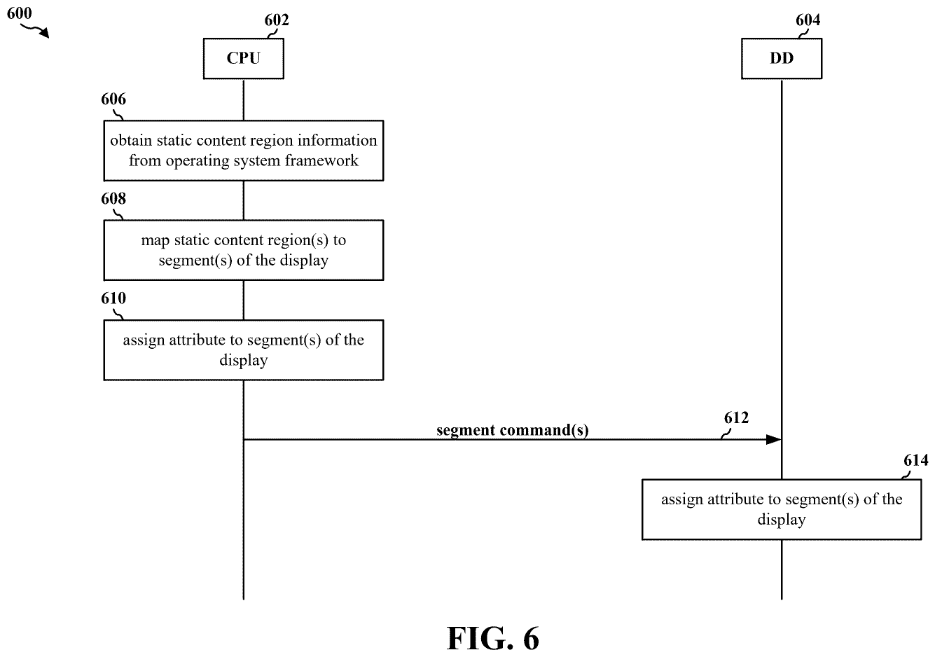

FIG. 6 is a call flow diagram 600 illustrating example communications between a computer processing unit (CPU) 602 and a device driver (DD) 604. The CPU 602 may be configured to operate one or more frameworks of a device, for example a framework (e.g., an operating system with user space libraries) and a power optimization layer that communicates with the framework. The DD 604 may control a display or a display processing unit (DPU). At 606, the CPU 602 may obtain static content region information from an operating system framework. For example, the CPU 602 may obtain pixel coordinates of a set of dirty content regions from an operating system framework and may determine the pixel coordinates of a set of static content regions by subtracting the pixel coordinates of the set of dirty content regions from the total pixel coordinates of the display.

At 608, the CPU 602 may map the determined set of static content regions to a set of segments of the display. In other words, the set of segments of the display may be correlated with the set of static content regions. At 610, the CPU 602 may assign an attribute to a subset of the set of segments. The attribute may include, for example, a brightness setting, a frame rate setting, a backlight power off setting, or a power off setting. The CPU 602 may select the subset of the set of segments by selecting segments that are associated with the set of static content regions but are not associated with any of the dirty content regions. In other words, if any of the segments contain even a single dirty pixel, the CPU 602 may refrain from adjusting the attribute of that segment.

The CPU 602 may output a set of segment commands 612 to the DD 604. The DD 604 may receive the set of segment commands 612 from the CPU 602. The set of segment commands 612 may include an indication of the associated attribute (e.g., a command to reduce a brightness of a set of segments, a command to reduce a frame rate of a set of segments, a command to turn off the backlight of a set of segments, a command to turn off a set of segments, and/or a command to set the brightness of a set of segments to zero. The set of segment commands 612 may indicate the subset of the set of segments assigned at 610. At 614, in response to receiving the set of segment commands 612 from the CPU 602, the DD 604 may assign the attribute to the set of segments of the display indicated by the set of segment commands 612.

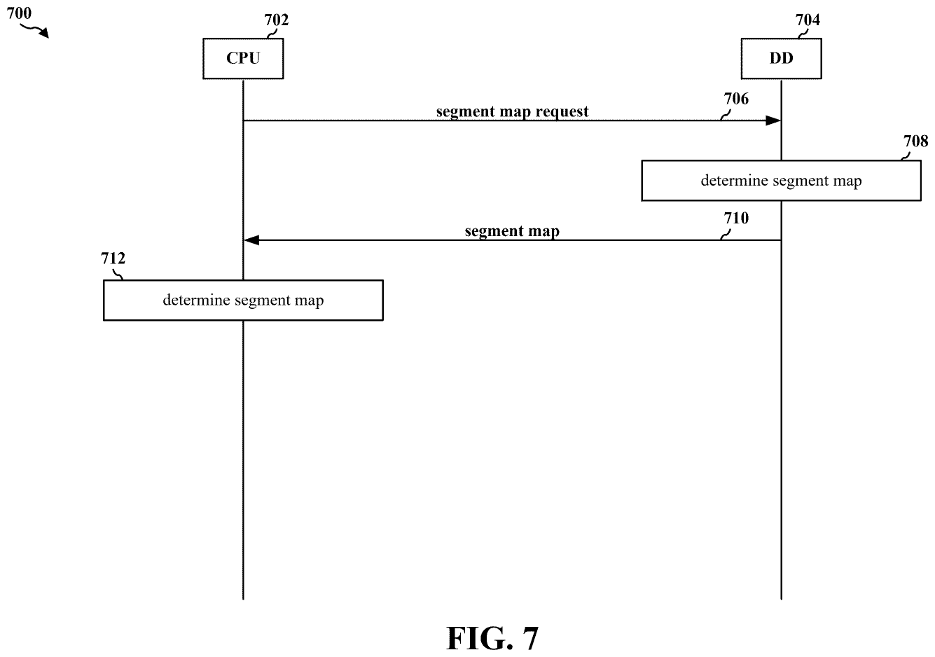

FIG. 7 is another call flow diagram 700 illustrating example communications between a CPU 702 and a DD 704, in accordance with one or more techniques of this disclosure. The CPU 702 may be configured to operate one or more frameworks of a device, for example an operating system framework and a power optimization framework. The DD 704 may control a display or a DPU. The CPU 702 may be configured to indicate to the DD 704 whether to adjust an attribute of a set of segments of a display controlled by the DD 704.

The CPU 702 may output a request 706 for a segment map to the DD 704. The DD 704 may obtain the request 706 for the segment map from the CPU 702. At 708, the DD 704 may determine a segment map between an identifier of a dirty/static region (e.g., pixel coordinates) and an identifier of a set of segments (e.g., segment identifiers, segment coordinates). In some aspects, the DD 704 may simply retrieve an existing segment map from a memory location. The DD 704 may output an indicator 710 of the segment map to the CPU 702. The CPU 702 may obtain the indicator 710 of the segment map from the DD 704. At 712, the CPU 702 may determine the segment map from the indicator 710 obtained from the DD 704. The CPU 702 may save the segment map to a memory for use in identifying segments to assign attributes to when identifying static regions of a display controlled by the DD 704.

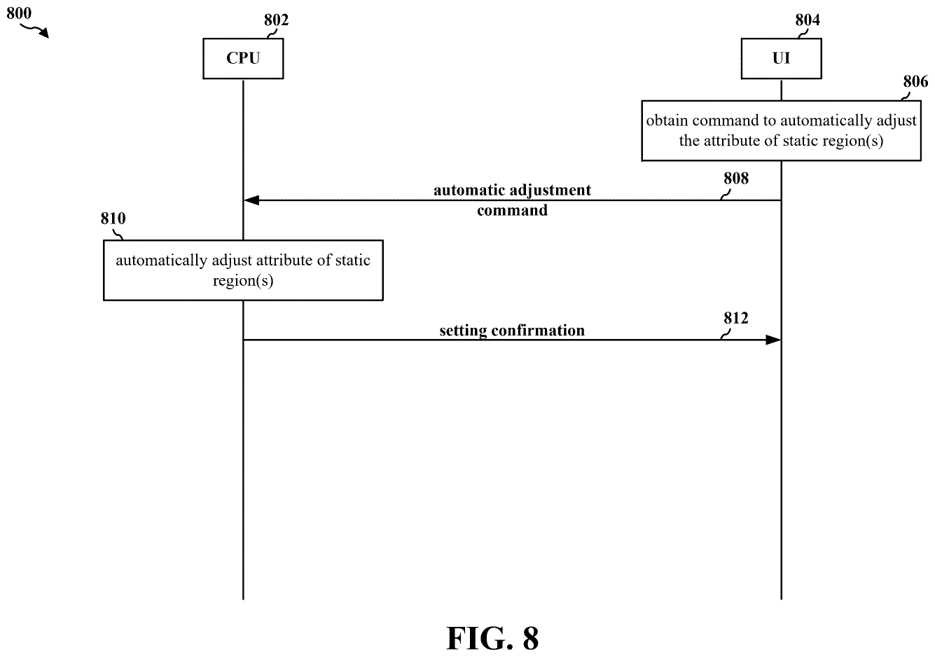

FIG. 8 is another call flow diagram 800 illustrating example communications between a CPU 802 and a user interface (UI) 804, in accordance with one or more techniques of this disclosure. The CPU 802 may be configured to operate one or more frameworks of a device, for example an operating system framework and a power optimization framework. The UI 804 may provide input from a user of a device, for example a touchscreen of a mobile device, a keyboard, or a speaker. The CPU 802 may be configured to indicate to a DD whether to adjust an attribute of a set of segments of a display.

At 806, the UI 804 may obtain an indicator of a command to automatically adjust the attribute of a set of static regions of a display. For example, the user may activate a setting to automatically adjust segments associated with static regions to save power at a mobile device. The UI 804 may output an indicator 808 of a command to automatically adjust the attribute of segments associated with static regions of a display to the CPU 802. The CPU 802 may obtain the indicator 808 of the command to automatically adjust the attribute of segments associated with static regions of a display. At 810, the CPU 802 may automatically adjust the attributes of a set of segments that are associated with a set of static regions of a display. The CPU 802 may refrain from automatically adjusting attributes of segments that are also associated with dirty regions of the display. The CPU 802 may output an indication 812 that the setting has been set to the UI 804. For example, the CPU 802 may indicate to a display that the setting is now active by displaying the word “automatic” next to a power saving option on a screen.

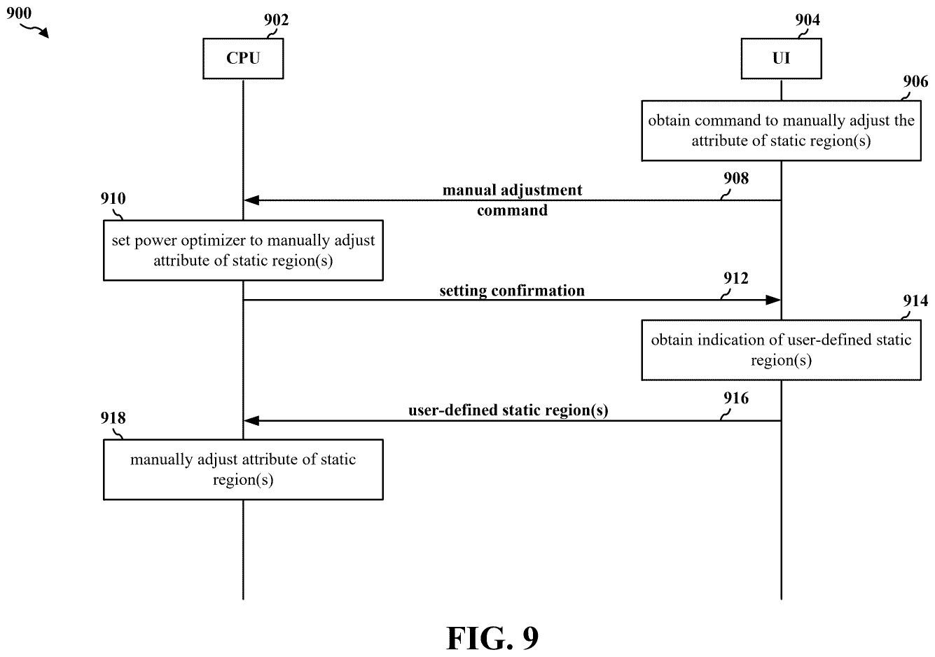

FIG. 9 is another call flow diagram 900 illustrating example communications between a CPU 902 and a user interface (UI) 904, in accordance with one or more techniques of this disclosure. The CPU 902 may be configured to operate one or more frameworks of a device, for example an operating system framework and a power optimization framework. The UI 904 may provide input from a user of a device, for example a touchscreen of a mobile device, a keyboard, or a speaker. The CPU 902 may be configured to indicate to a DD whether to adjust an attribute of a set of segments of a display.

At 906, the UI 904 may obtain an indicator of a command to manually adjust the attribute of a set of static regions of a display. For example, the user may activate a setting to manually adjust segments associated with static regions to save power at a mobile device. The UI 904 may output an indicator 908 of a command to manually adjust the attribute of segments associated with static regions of a display to the CPU 902. The CPU 902 may obtain the indicator 908 of the command to manually adjust the attribute of segments associated with static regions of a display. At 910, the CPU 902 may set a power optimization layer to manually adjust the attributes of a set of segments that are associated with a set of static regions of a display. For example, the power optimization layer may wait to adjust attributes until after it receives some sort of input or signal from the UI 904. The CPU 902 may output an indication 912 that the setting has been set to the UI 904. For example, the CPU 902 may indicate to a display that the setting is now active by displaying the word “manual” next to a power saving option on a screen.

At 914, the UI 904 may obtain an indicator of a user-defined set of static regions of a display from a user, also referred to as an adjustable content region. For example, the UI 904 may receive a series of swipes that indicate that a region of a display should be turned off if associated with a static region as indicated by an operating system framework. The UI 904 may output an indication 916 of the set of user-defined static regions to the CPU 902. The CPU 902 may obtain the indication 916 of the set of user-defined static regions from the UI 904. At 918, the CPU 902 may adjust the attributes of the set of segments that were indicated by the set of user-defined static regions, and that were indicated by an operating system framework to be associated with a set of static regions. The CPU 902 may refrain from adjusting attributes of segments that are also associated with dirty regions of the display.

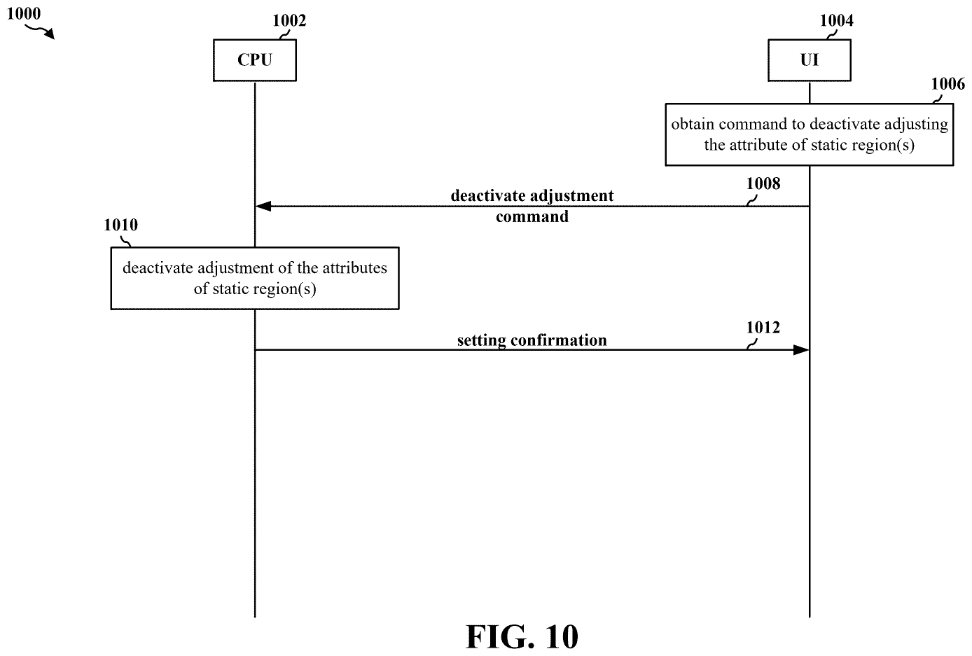

FIG. 10 is another call flow diagram 1000 illustrating example communications between a CPU 1002 and a user interface (UI) 1004, in accordance with one or more techniques of this disclosure. The CPU 1002 may be configured to operate one or more frameworks of a device, for example an operating system framework and a power optimization framework. The UI 1004 may provide input from a user of a device, for example a touchscreen of a mobile device, a keyboard, or a speaker. The CPU 1002 may be configured to indicate to a DD whether to adjust an attribute of a set of segments of a display.

At 1006, the UI 1004 may obtain an indicator of a command to deactivate adjusting the attribute of a set of static regions of a display. For example, the user may deactivate a setting to automatically or manually adjust segments associated with static regions to save power at a mobile device. The UI 1004 may output an indicator 1008 of a command to deactivate adjusting the attribute of segments associated with static regions of a display to the CPU 1002. The CPU 1002 may obtain the indicator 1008 of the command to deactivate adjusting the attribute of segments associated with static regions of a display. At 1010, the CPU 1002 may deactivate adjusting the attributes of a set of segments that are associated with a set of static regions of a display. The CPU 1002 may output an indication 1012 that the setting has been set to the UI 1004. For example, the CPU 1002 may indicate to a display that the setting is now deactivated by displaying the word “off”next to a power saving option on a screen.

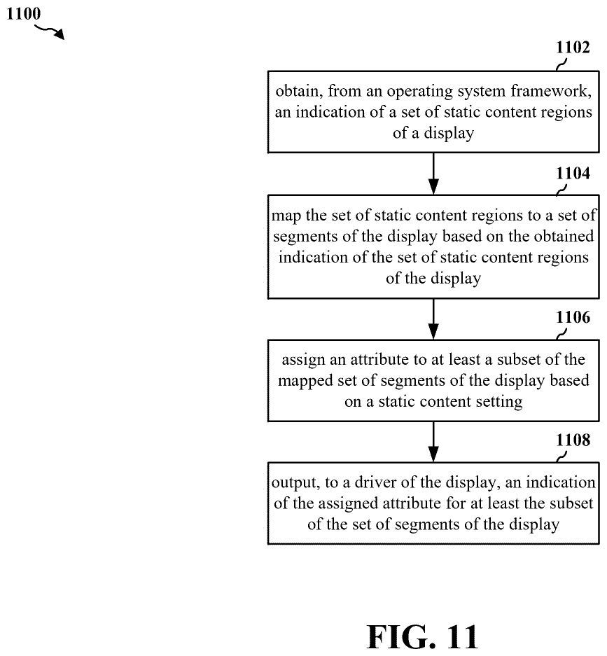

FIG. 11 is a flowchart 1100 of an example method of display processing in accordance with one or more techniques of this disclosure. The method may be performed by an apparatus, such as an apparatus for display processing, a CPU, a display processing unit (DPU) or other display processor, a GPU, a wireless communication device, and the like, as used in connection with the aspects of FIGS. 1-3, 4A-4B, 5A-5D, and 6-10.

At 1102, the apparatus may obtain, from an operating system framework, an indication of a set of static content regions of a display. For example, referring to FIG. 6, the CPU 602 may, at 606, obtain, from a framework (e.g., an operating system API), an indication of a set of static content regions of a display. For example, the operating system may provide coordinates of dirty content regions of a display, which the CPU 602 may use to determine static content regions of the display, as any regions of the display that do not have dirty content may inherently have static content.

At 1104, the apparatus may map the set of static content regions to a set of segments of the display based on the obtained indication of the set of static content regions of the display. For example, referring to FIG. 6, the CPU 602 may, at 608, map the set of static content regions to a set of segments of the display (e.g., the segments 504, 506, 508, 510, 512, 514, 516, 518, 520, 522, 524, 526, 528, and 530 in FIG. 5A of the display 502) based on the obtained indication of the set of static content regions of the display.

At 1106, the apparatus may assign an attribute to at least a subset of the mapped set of segments of the display based on a static content setting. For example, referring to FIG. 6, the CPU 602 may, at 610, assign an attribute to at least a subset of the set of segments of the display, mapped at 1106, based on a static content setting. The static content setting may be defined by a user in a settings app of a mobile device, or may be defined by a default content setting (e.g., all static regions have a deactivated backlight after 2 minutes of static content in a segment).

At 1108, the apparatus may output, to a driver of the display, an indication of the assigned attribute for at least the subset of the set of segments of the display. For example, referring to FIG. 6, the CPU 602 may output a set of segment commands 612 to the DD 604 of a display. The set of segment commands may include an indication of the assigned attribute for at least the subset of the set of segments of the display, for example a variable that correlates with the assigned attribute (e.g., a brightness level) and a set of variables that correlate with the subset of the set of segments (e.g., an array identifying which segments of the display are affected).

In configurations, a method or an apparatus for display processing is provided. The apparatus may be a DPU, a display processor, or some other processor that may perform display processing. In aspects, the apparatus may be the display processor 127 within the device 104 or may be some other hardware within the device 104 or another device. The apparatus may include means for obtaining, from an operating system framework, an indication of a set of static content regions of a display. The apparatus may further include means for mapping the set of static content regions to a set of segments of the display based on the obtained indication of the set of static content regions of the display. The apparatus may further include means for assigning an attribute to at least a subset of the mapped set of segments of the display based on a static content setting. The apparatus may further include means for outputting, to a driver of the display, an indication of the assigned attribute for at least the subset of the set of segments of the display. The set of segments may include segments of a set of LED panels. The apparatus may further include means for mapping the set of static content regions to the set of segments of the display by (a) obtaining, from the driver of the display, a map that correlates sets of pixel coordinates to each segment of the set of segments of the set of LED panels, and (b) mapping the set of static content regions to the set of segments of the display based on the obtained map that correlates the sets of pixel coordinates to each segment of the set of segments of the set of LED panels. The attribute may include a brightness setting. The brightness setting may be less than a default brightness setting of the display. The attribute may include a frame rate setting. The frame rate setting may be less than a default frame rate setting of the display. The attribute may include a backlight power off setting. The attribute may include a power off setting. The apparatus may further include means for obtaining, from the operating system framework, the indication of the set of static content regions of the display by (a) obtaining, from the operating system framework, an indication of a set of dirty content regions of the display, and (b) determining the set of static content regions of the display based on the obtained indication of the set of dirty content regions of the display. The apparatus may further include means for mapping the set of dirty content regions of the display to a second set of segments of the display. The apparatus may further include means for refraining from outputting, to the driver of the display, the indication of the assigned attribute for the second set of segments based on the mapped second set of segments of the display. The apparatus may further include means for obtaining, from a user interface, an indication to automatically adjust the attribute for at least a portion of the set of segments of the display. The apparatus may further include means for refraining from outputting, to the driver of the display, the indication of the assigned attribute for the second set of segments based on the mapped second set of segments by refraining from outputting, to the driver of the display, the indication of the assigned attribute for the second set of segments in response to the indication to automatically adjust the attribute for at least the portion of the set of segments of the display. The apparatus may further include means for obtaining, from a user interface, an indication of a set of adjustable content regions of the display. The apparatus may further include means for assigning the attribute to at least the subset of the mapped set of segments of the display based on the static content setting by assigning the attribute to at least the subset of the mapped set of segments of the display further based on the obtained indication of the set of adjustable content regions of the display. The apparatus may further include means for obtaining, from the user interface, an indication to manually select the set of adjustable content regions of the display. The apparatus may further include means for assigning the attribute to at least the subset of the mapped set of segments of the display further based on the obtained indication of the set of adjustable content regions of the display by assigning the attribute to at least the subset of the mapped set of segments of the display further based on the obtained indication of the set of adjustable content regions of the display in response to the indication to manually select the set of adjustable content regions of the display. The apparatus may further include means for obtaining, from a user interface, an indication of the static content setting before assigning the attribute to at least the subset of the set of segments of the display based on the static content setting. It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing, comprising: obtaining, from an operating system framework, an indication of a set of static content regions of a display; mapping the set of static content regions to a set of segments of the display based on the obtained indication of the set of static content regions of the display; assigning an attribute to at least a subset of the mapped set of segments of the display based on a static content setting; and outputting, to a driver of the display, an indication of the assigned attribute for at least the subset of the set of segments of the display.

Aspect 2 is the method of aspect 1, wherein the set of segments comprises segments of a set of light emitting diode (LED) panels.

Aspect 3 is the method of aspect 1, wherein the set of segments comprises segments of a set of light emitting diode (LED) panels, wherein mapping the set of static content regions to the set of segments of the display comprises: obtaining, from the driver of the display, a map that correlates sets of pixel coordinates to each segment of the set of segments of the set of LED panels; and mapping the set of static content regions to the set of segments of the display based on the obtained map that correlates the sets of pixel coordinates to each segment of the set of segments of the set of LED panels.

Aspect 4 is the method of aspect 1, wherein the attribute comprises at least one of: a brightness setting, wherein the brightness setting is less than a default brightness setting of the display; a frame rate setting, wherein the frame rate setting is less than a default frame rate setting of the display; a backlight power off setting; or a power off setting.

Aspect 5 is the method of aspect 1, wherein obtaining, from the operating system framework, the indication of the set of static content regions of the display comprises: obtaining, from the operating system framework, an indication of a set of dirty content regions of the display; and determining the set of static content regions of the display based on the obtained indication of the set of dirty content regions of the display.

Aspect 6 is the method of aspect 5, further comprising: mapping the set of dirty content regions of the display to a second set of segments of the display; and refraining from outputting, to the driver of the display, the indication of the assigned attribute for the second set of segments based on the mapped second set of segments of the display.

Aspect 7 is the method of aspect 6, further comprising: obtaining, from a user interface, an indication to automatically adjust the attribute for at least a portion of the set of segments of the display, wherein refraining from outputting, to the driver of the display, the indication of the assigned attribute for the second set of segments based on the mapped second set of segments comprises: refraining from outputting, to the driver of the display, the indication of the assigned attribute for the second set of segments in response to the indication to automatically adjust the attribute for at least the portion of the set of segments of the display.

Aspect 8 is the method of aspect 1, further comprising: obtaining, from a user interface, an indication of a set of adjustable content regions of the display, wherein assigning the attribute to at least the subset of the mapped set of segments of the display based on the static content setting comprises: assigning the attribute to at least the subset of the mapped set of segments of the display further based on the obtained indication of the set of adjustable content regions of the display.

Aspect 9 is the method of aspect 8, further comprising: obtaining, from the user interface, an indication to manually select the set of adjustable content regions of the display, wherein assigning the attribute to at least the subset of the mapped set of segments of the display further based on the obtained indication of the set of adjustable content regions of the display comprises: assigning the attribute to at least the subset of the mapped set of segments of the display further based on the obtained indication of the set of adjustable content regions of the display in response to the indication to manually select the set of adjustable content regions of the display.

Aspect 10 is the method of aspect 1, further comprising: obtaining, from a user interface, an indication of the static content setting before assigning the attribute to at least the subset of the set of segments of the display based on the static content setting.

Aspect 11 is an apparatus for display processing comprising a processor coupled to a memory and, based on information stored in the memory, the processor is configured to implement a method as in any of aspects 1-10.

Aspect 12 may be combined with aspect 11 and comprises that the apparatus is a wireless communication device.

Aspect 13 is an apparatus for display processing comprising means for implementing a method as in any of aspects 1-10.

Aspect 14 is a computer-readable medium (e.g., a non-transitory computer readable-medium) storing computer executable code, the computer executable code, when executed by a processor, causes the processor to implement a method as in any of aspects 1-10.

Various aspects have been described herein. These and other aspects are within the scope of the following claims.

What is claimed is:

1. An apparatus for display processing, comprising:
a memory; and
a processor coupled to the memory and, based on information stored in the memory, the processor is configured to:
obtain, from an operating system framework, an indication of a set of static content regions of a display;
map the set of static content regions to a set of segments of the display based on the obtained indication of the set of static content regions of the display;
assign an attribute to at least a subset of the mapped set of segments of the display based on a static content setting; and
output, to a driver of the display, an indication of the assigned attribute for at least the subset of the set of segments of the display.

2. The apparatus of claim 1, wherein the set of segments comprises segments of a set of light emitting diode (LED) panels.

3. The apparatus of claim 2, wherein, to map the set of static content regions to the set of segments of the display, the processor is configured to:
obtain, from the driver of the display, a map that correlates sets of pixel coordinates to each segment of the set of segments of the set of LED panels; and
map the set of static content regions to the set of segments of the display based on the obtained map that correlates the sets of pixel coordinates to each segment of the set of segments of the set of LED panels.

4. The apparatus of claim 1, wherein the attribute comprises at least one of:
a brightness setting, wherein the brightness setting is less than a default brightness setting of the display;
a backlight power off setting; or
a power off setting.

5. The apparatus of claim 1, wherein, to obtain, from the operating system framework, the indication of the set of static content regions of the display, the processor is configured to:
obtain, from the operating system framework, an indication of a set of dirty content regions of the display; and
determine the set of static content regions of the display based on the obtained indication of the set of dirty content regions of the display.

6. The apparatus of claim 5, wherein the processor is further configured to:
map the set of dirty content regions of the display to a second set of segments of the display; and
refrain from outputting, to the driver of the display, the indication of the assigned attribute for the second set of segments based on the mapped second set of segments of the display.

7. The apparatus of claim 6, wherein the processor is further configured to:
obtain, from a user interface, an indication to automatically adjust the attribute for at least a portion of the set of segments of the display, wherein, to refrain from outputting, to the driver of the display, the indication of the assigned attribute for the second set of segments based on the mapped second set of segments, the processor is configured to:
refrain from outputting, to the driver of the display, the indication of the assigned attribute for the second set of segments in response to the indication to automatically adjust the attribute for at least the portion of the set of segments of the display.

8. The apparatus of claim 1, wherein the processor is further configured to:
obtain, from a user interface, an indication of a set of adjustable content regions of the display, wherein, to assign the attribute to at least the subset of the mapped set of segments of the display based on the static content setting, the processor is configured to:
assign the attribute to at least the subset of the mapped set of segments of the display further based on the obtained indication of the set of adjustable content regions of the display.

9. The apparatus of claim 8, wherein the processor is further configured to:
obtain, from the user interface, an indication to manually select the set of adjustable content regions of the display, wherein, to assign the attribute to at least the subset of the mapped set of segments of the display further based on the obtained indication of the set of adjustable content regions of the display, the processor is configured to:
assign the attribute to at least the subset of the mapped set of segments of the display further based on the obtained indication of the set of adjustable content regions of the display in response to the indication to manually select the set of adjustable content regions of the display.

10. The apparatus of claim 1, wherein the processor is further configured to:
obtain, from a user interface, an indication of the static content setting before assigning the attribute to at least the subset of the set of segments of the display based on the static content setting.

11. A method of display processing, comprising:
obtaining, from an operating system framework, an indication of a set of static content regions of a display;
mapping the set of static content regions to a set of segments of the display based on the obtained indication of the set of static content regions of the display;
assigning an attribute to at least a subset of the mapped set of segments of the display based on a static content setting; and
outputting, to a driver of the display, an indication of the assigned attribute for at least the subset of the set of segments of the display.

12. The method of claim 11, wherein the set of segments comprises segments of a set of light emitting diode (LED) panels, wherein mapping the set of static content regions to the set of segments of the display comprises:
obtaining, from the driver of the display, a map that correlates sets of pixel coordinates to each segment of the set of segments of the set of LED panels; and
mapping the set of static content regions to the set of segments of the display based on the obtained map that correlates the sets of pixel coordinates to each segment of the set of segments of the set of LED panels.

13. The method of claim 11, wherein the attribute comprises at least one of:
a brightness setting, wherein the brightness setting is less than a default brightness setting of the display;
a frame rate setting, wherein the frame rate setting is less than a default frame rate setting of the display;
a backlight power off setting; or
a power off setting.

14. The method of claim 11, wherein obtaining, from the operating system framework, the indication of the set of static content regions of the display comprises:
obtaining, from the operating system framework, an indication of a set of dirty content regions of the display; and
determining the set of static content regions of the display based on the obtained indication of the set of dirty content regions of the display.

15. The method of claim 14, further comprising:
mapping the set of dirty content regions of the display to a second set of segments of the display; and
refraining from outputting, to the driver of the display, the indication of the assigned attribute for the second set of segments based on the mapped second set of segments of the display.

16. The method of claim 15, further comprising:
obtaining, from a user interface, an indication to automatically adjust the attribute for at least a portion of the set of segments of the display, wherein refraining from outputting, to the driver of the display, the indication of the assigned attribute for the second set of segments based on the mapped second set of segments comprises:
refraining from outputting, to the driver of the display, the indication of the assigned attribute for the second set of segments in response to the indication to automatically adjust the attribute for at least the portion of the set of segments of the display.

17. The method of claim 11, further comprising:
obtaining, from a user interface, an indication of a set of adjustable content regions of the display, wherein assigning the attribute to at least the subset of the mapped set of segments of the display based on the static content setting comprises:
assigning the attribute to at least the subset of the mapped set of segments of the display further based on the obtained indication of the set of adjustable content regions of the display.

18. The method of claim 17, further comprising:
obtaining, from the user interface, an indication to manually select the set of adjustable content regions of the display, wherein assigning the attribute to at least the subset of the mapped set of segments of the display further based on the obtained indication of the set of adjustable content regions of the display comprises:
assigning the attribute to at least the subset of the mapped set of segments of the display further based on the obtained indication of the set of adjustable content regions of the display in response to the indication to manually select the set of adjustable content regions of the display.

19. The method of claim 11, further comprising:
obtaining, from a user interface, an indication of the static content setting before assigning the attribute to at least the subset of the set of segments of the display based on the static content setting.

20. A computer-readable medium storing computer executable code, the computer executable code, when executed by a processor, causes the processor to:
obtain, from an operating system framework, an indication of a set of static content regions of a display;
map the set of static content regions to a set of segments of the display based on the obtained indication of the set of static content regions of the display;
assign an attribute to at least a subset of the mapped set of segments of the display based on a static content setting; and
output, to a driver of the display, an indication of the assigned attribute for at least the subset of the set of segments of the display.
